(19) United States
(12) Patent Application Publication
(10) Pub. No.: US 2009/0132250 A1
(43) Pub. Date: May 21, 2009

(54) ROBOT APPARATUS WITH VOCAL INTERACTIVE FUNCTION AND METHOD THEREFOR

(75) Inventors: TSU-LI CHIANG, Tu-Cheng (TW); CHUAN-HONG WANG, Tu-Cheng (TW); KUO-PAO HUNG, Tu-Cheng (TW); KUAN-HONG HSIEH, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/239,732

(22) Filed: Sep. 26, 2008

(30) Foreign Application Priority Data
Nov. 16, 2007 (CN) 200710124554.2

(51) Int. Cl. G10L 15/04

(52) U.S. Cl. 704/251; 901/46; 704/E15.001

(57) ABSTRACT

The present invention provides a robot apparatus with a vocal interactive function. The robot apparatus 1 receives a vocal input from the ambient environment, such as a user, and the vocal input is a conversation voice or an evaluation voice. The robot apparatus 1 receives a conversation voice from the user at first, and generates output data responding to the conversation voice, and receives an evaluation voice from the user. The evaluation voice is a response from the user to the output data, and the robot apparatus 1 updates a weighted value of the output data based on the user response. Consequently, the robot apparatus may output different and variable output data when receiving the same vocal input. The present invention also provides a vocal interactive method adapted for the robot apparatus.

### TECHNICAL FIELD

The disclosure relates to robot apparatuses and, more particularly, to a robot apparatus with a vocal interactive function and a vocal interactive method for the robot apparatus according to weighted values of all output data corresponding to a conversation voice.

### GENERAL BACKGROUND

There are a variety of robots in the market today, such as electronic toys, electronic pets, and the like. Some robots may output a relevant sound when detecting a predetermined sound from the ambient environment, such as a user. However, when the predetermined sound is detected, the robot would only output one predetermined kind of sound. Generally, before the robot is available for market distribution, manufactures store predetermined input sounds, predetermined output sounds, and relationships between the input sounds and the output sounds in the robot apparatus. When detecting an environment sound from the ambient environment, the robot outputs an output sound according to a relationship between the input sound and the output sound. Consequently, the robot only outputs one fixed output according to one fixed input, making the robot repetitiously dull and boring.

Accordingly, what is needed in the art is a robot apparatus that overcomes the aforementioned deficiencies.

### SUMMARY

A robot apparatus with a vocal interactive function is provided. The robot apparatus comprises a microphone, a storage unit, a recognizing module, a judging module, a selection module, an output module, and an updating module. The microphone is configured for collecting a vocal input from a user, wherein the vocal input is a conversation voice or an evaluation voice, and the evaluation voice is a response to the robot apparatus output. The storage unit is configured for storing a plurality of output data corresponding to conversation voices, a weighted value of each of the output data, and an evaluation level table, wherein the evaluation level table stores a plurality of evaluation voices and an evaluation level of each of the evaluation voices, and the weighted value of the output data is a direct ratio to the evaluation level of an evaluation voice responding to the output data. The recognizing module is capable of recognizing the vocal input.

The judging module is capable of determining that the vocal input is a conversation voice or an evaluation voice. The selection module is capable of selecting one of the output data based on the weighted values of all the output data corresponding to a conversation voice, if the vocal input is a conversation voice. The output module is capable of outputting the selected output data responding to the conversation voice and recording the selected output data. The updating module is capable of acquiring an evaluation level of the evaluation voice responding to the output data in the evaluation level table, calculating the weighted value of the output data according to the evaluation level, and updating the weighted value, if the vocal input is an evaluation voice.

Other advantages and novel features will be drawn from the following detailed description with reference to the accompanying drawings.

### BRIEF DESCRIPTION OF THE DRAWINGS

The components in the drawings are not necessarily drawn to scale, the emphasis instead being placed upon clearly illustrating the principles of the robot apparatus. Moreover, in the drawings, like reference numerals designate corresponding parts throughout the several views.

FIG. 1 is a block diagram of a hardware infrastructure of a robot apparatus in accordance with an exemplary embodiment.

FIG. 2 is a schematic diagram of an output table of the robot apparatus of FIG. 1.

FIG. 3 is a schematic diagram of an evaluation level table of the robot apparatus of FIG. 1.

FIG. 4 is a flowchart illustrating a vocal interactive method that could be utilized by the robot apparatus of FIG. 1.

### DETAILED DESCRIPTION OF THE EMBODIMENTS

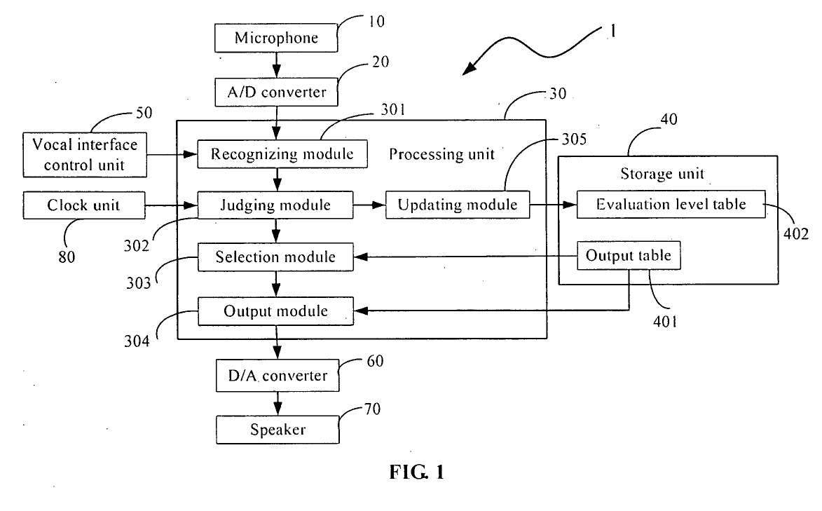

FIG. 1 is a block diagram of a hardware infrastructure of a robot apparatus in accordance with an exemplary embodiment. The robot apparatus 1 receives a vocal input from the ambient environment, such as a user, and the vocal input is a conversation voice or an evaluation voice. The robot apparatus 1 receives a conversation voice from the user at first, generates output data responding to the conversation voice, and receives an evaluation voice from the user. The evaluation voice is a response from the user to the output data, and the robot apparatus 1 updates a weighted value of the output data based on the user response. The robot apparatus 1 includes a microphone 10, an analog to digital (A/D) converter 20, a processing unit 30, a storage unit 40, a vocal interactive control unit 50, a digital to analog (D/A) converter 60, a speaker 70, and a clock unit 80.

In the exemplary embodiment, the vocal interactive control unit 50 is configured for controlling the robot apparatus 1 to enter a vocal interactive mode or a silent mode. When the robot apparatus 1 is in the vocal interactive mode, the processing unit 30 controls the microphone 10 to collect analog signals of a vocal input from the user. The A/D converter 20 converts the analog signals of the vocal input into digital signals. The processing unit 30 recognizes the digital signals of the vocal input and determines that the vocal input is a conversation voice or an evaluation voice.

When the robot apparatus 1 is in the silent mode, even if the microphone 10 collects the analog signals of the vocal input, the robot apparatus 1 does not respond to the vocal input and generate any output. In another exemplary embodiment, the robot apparatus 1 collects the vocal input at any time and responds to the vocal input.

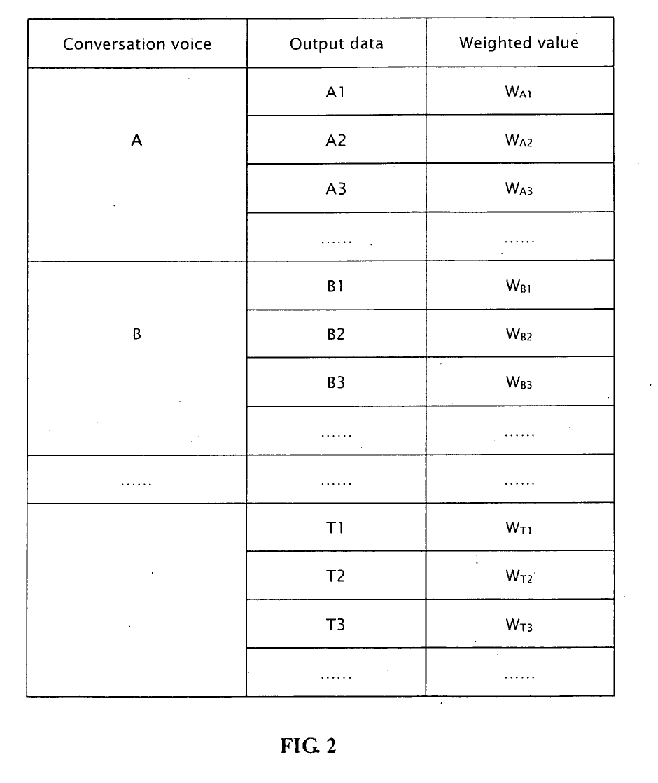

The storage unit 40 stores a plurality of output data, an output table 401, and an evaluation level table 402. The output table 401 (see FIG. 2) includes a conversation voice column, an output data column, and a weighted value column. The conversation voice column records a plurality of conversation voices, such as A, B, and the like. The conversation voices may be “what is the weather”, “what's the matter”, etc. The output data column records a plurality of output data. The output data is a response from the robot apparatus 1 to the conversation voice. For example, the output data corresponding to the conversation voice A include A1, A2, A3, etc. The output data column further records output data corresponding to an undefined conversation voice, which are not recorded in the conversation voice column. For example, the output data corresponding to the undefined conversation voice include T1, T2, T3, etc.

The weighted value column records a weighted value assigned to the output data. For example, a weighted value of the output data B3 is W_{B3}. The weighted value can be preconfigured according to a preference. The preference can be based on being the dad, the mom, etc. For example, the weighted value of a more preferred output can be increased manually and the weighted value of a less favored output can be decreased manually.

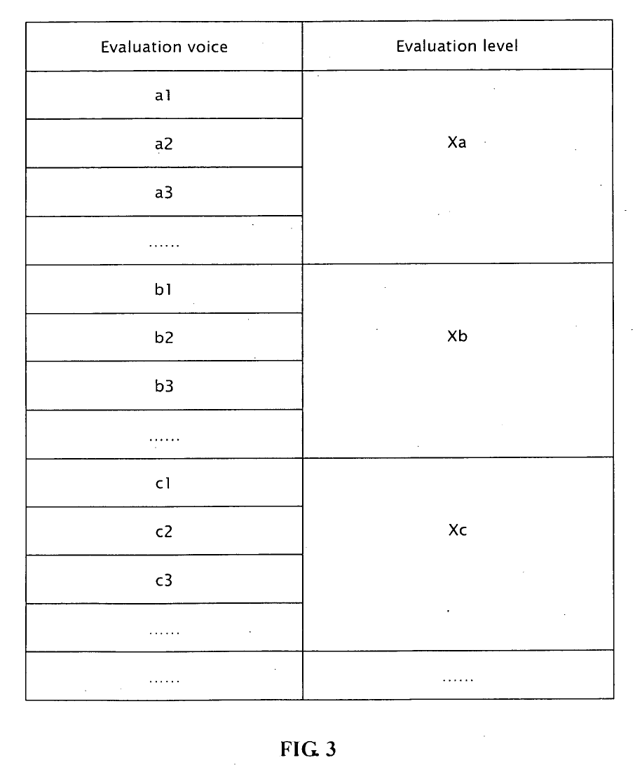

The evaluation level table 402 is configured for responding and evaluating all the output data in the output table 401. The evaluation level table 402 (see FIG. 3) includes an evaluation voice column and an evaluation level column. The evaluation voice column records a plurality of evaluation voices, such as a1, a2, a3, and the like. The evaluation voices are configured to respond to the output data. The evaluation voices may be “good”, “wrong”, etc. The evaluation level column records evaluation levels corresponding to the evaluation voices. For example, the evaluation level of the evaluation voices a1, a2, a3 is Xa, that is, the evaluation voices a1, a2, a3 have the same evaluation level.

The weighted value of the output data is a direct ratio to the evaluation level of an evaluation voice responding to the output data. That is, the higher the evaluation level of the evaluation voice is, the higher the weighted value of the output data is.

The processing unit 30 includes a recognizing module 301, a judging module 302, a selection module 303, an output module 304, and an updating module 305.

The recognizing module 301 is configured for recognizing the digital signals of the vocal input from the A/D converter 20. The clock unit 80 is configured for measuring time. The judging module 302 is configured for determining that the vocal input is the conversation voice or the evaluation voice. In the exemplary embodiment, the judging module 302 acquires current time from the clock unit 80, and judges whether the robot apparatus 1 generated output data in a predetermined time period before the current time. For example, if the predetermined time period is 30 seconds and the current time is 10:20:30 pm, so the judging module 302 judges whether the robot apparatus 1 generated the output data from 10:20 pm to 10:20:30 pm.

If the robot apparatus 1 did not generate the output data in the predetermined time period before the current time, the judging module 302 determines that the vocal input is a conversation voice. The selection module 303 is configured for acquiring all the output data corresponding to the conversation voice in the output table 401, and selecting one of the output data based on the weighted values of all the acquired output data. That is, the higher the weighted value of the selected output data is, the higher the probability of being selected is. For example, suppose the conversation voice is A and the weighted values W_{A1}, W_{A2}, W_{A3}, of all the output data A1, A2, A3 are 5, 7, 9, the selection module 303 selects the output data A3 because the output data A3 has the highest weighted value.

The output module 304 is configured for acquiring the selected output data in the storage unit 40, outputting the selected output data, and recording the selected output data and the current time from the clock unit 80. The D/A converter 60 converts the selected output data into analog signals. The speaker 70 outputs a vocal output of the selected output data.

If the robot apparatus 1 generated the output data in the predetermined time period before the current time, the judging module 302 judges whether the vocal input is from the evaluation level table 402, that is, whether the vocal input is the evaluation voice in the evaluation level table 402. If the vocal input is from the evaluation level table 402, the judging module 302 determines that the vocal input is the evaluation voice for the output data, the updating module 305 is configured for acquiring an evaluation level of the evaluation voice from the evaluation level table 402, calculating the weighted value of the output data according to the evaluation level, and updating the weighted value in the output table 401. For example, if the output data is A1 and the evaluation voice responding to the output data is b2, the weighted value of the output data is V′_{A1}=f{V_{A1}, (Xb)}, wherein V′_{A1} is the updated weighted value, V_{A1} is the previous weighted value, and Xb is the evaluation level of the evaluation voice b2.

Once the robot apparatus 1 receives an evaluation voice responding to output data, that is, the robot apparatus 1 generated the output data in the predetermined time period before the current time before receiving the evaluation voice, the updating module 305 updates the weighted value of the output data based on an evaluation level of the evaluation voice. If the robot apparatus 1 does not acquire an evaluation level of an evaluation voice responding to the output data, the weighted value of the output data is the same. In another exemplary embodiment, the judging module 302 directly determines that the vocal input is the conversation voice or the evaluation voice, that is, whether the vocal input is from the evaluation level table 402. If the vocal input is from the evaluation level table 402, the vocal input is an evaluation voice. If the vocal input is not from the evaluation level table 402, the vocal input is a conversation voice.

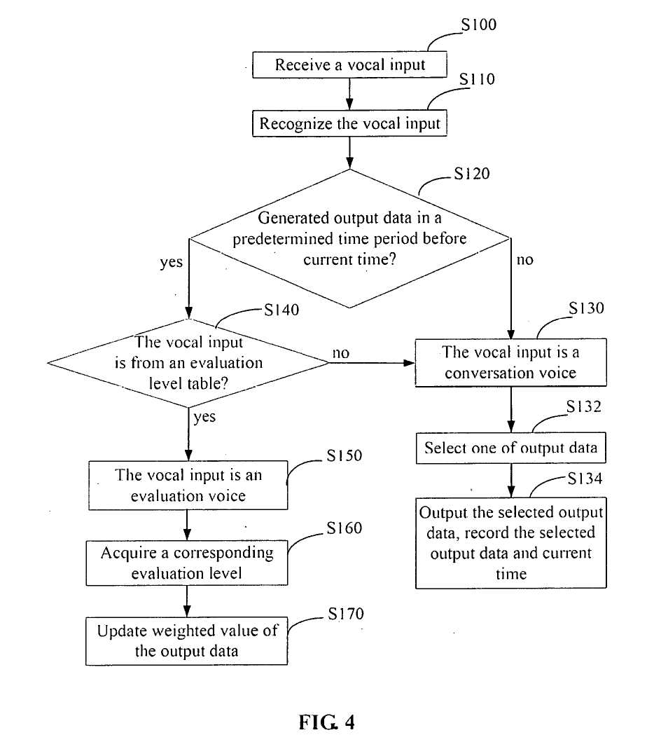

FIG. 4 is a flowchart illustrating a vocal interactive method that could be utilized by the robot apparatus of FIG. 1. In step S100, the microphone 10 receives the analog signals of the vocal input from the user, and the A/D converter 20 converts the analog signals into the digital signals. In step S110, the recognizing module 301 recognizes the digital signals of the vocal input. In step S120, the judging module 302 acquires the current time from the clock unit 80, and judges whether the robot apparatus 1 generated the output data in the predetermined time period before the current time.

If the robot apparatus 1 did not generate the output data, in step S130, the judging module 302 determines that the vocal input is a conversation voice. In step S132, the selection module 303 selects one of the output data corresponding to the conversation voice according to the weighted values of all the output data. In step S134, the output module 303 acquires and outputs the selected output data in the storage unit 40, the D/A converter 60 converts the selected output data into the analog signals, the speaker 70 outputs the vocal output of the selected output data, and the output module 304 records the selected output data and the current time.

If the robot apparatus 1 generated the output data, in step S140, the judging module 302 judges whether the vocal input is from the evaluation level table 402. If the vocal input is not from the evaluation level table 402, the judging module 402 determines that the vocal input is the conversation voice, that is, the robot apparatus 1 receives another conversation voice from the user, and the procedure returns to step SI 30. If the vocal input is from the evaluation level table 402, in step S150, the judging module 302 determines that the vocal input is the evaluation voice responding to the output data. In step S160, the updating module 305 acquires the evaluation level corresponding to the evaluation voice. In step S170, the updating module 305 calculates the weighted value of the output data according to the acquired evaluation level and updates the weighted value. When the robot apparatus 1 receives a vocal input from the user again, the procedure starts again.

In addition, in another exemplary embodiment, after the recognizing module 301 recognizes the vocal input, the judging module 302 directly determines that the vocal input is a conversation voice or an evaluation voice, that is, the judging module 302 judges whether the vocal input is from the evaluation level table. In other words, the method is performed without step S120.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A robot apparatus with a vocal interactive function, comprising:
a microphone for collecting a vocal input from a user, wherein the vocal input is a conversation voice or an evaluation voice, and the evaluation voice is a response to the robot apparatus output;
a storage unit for storing a plurality of output data corresponding to conversation voices, a weighted value of each of the output data, and an evaluation level table, wherein the evaluation level table stores a plurality of evaluation voices and an evaluation level of each of the evaluation voices, and the weighted value of the output data is a direct ratio to the evaluation level of an evaluation voice responding to the output data;
a recognizing module capable of recognizing the vocal input;
a judging module capable of determining that the vocal input is a conversation voice or an evaluation voice;
a selection module capable of selecting one of the output data based on the weighted values of all the output data corresponding to a conversation voice, if the vocal input is a conversation voice;
an output module capable of outputting the selected output data responding to the conversation voice and recording the selected output data; and
an updating module capable of acquiring an evaluation level of the evaluation voice responding to the output data in the evaluation level table, calculating the weighted value of the output data according to the evaluation level, and updating the weighted value, if the vocal input is an evaluation voice.

2. The robot apparatus as recited in claim 1, wherein the storage unit further stores output data corresponding to an undefined conversation voice that is not recorded in the storage unit.

3. The robot apparatus as recited in claim 1, further comprising a vocal interactive control unit capable of controlling the microphone to collect the vocal input.

4. The robot apparatus as recited in claim 1, further comprising a clock unit for measuring time.

5. The robot apparatus as recited in claim 4, wherein the output module records current time from the clock unit when outputting the output data.

6. The robot apparatus as recited in claim 5, wherein the judging module judges the vocal input in a manner of judging whether the robot apparatus generated the output data in a predetermined time period before the current time.

7. The robot apparatus as recited in claim 6, wherein if the robot apparatus did not generate the output data in the predetermined time period before the current time, the judging module determines that the vocal input is a conversation voice; if the robot apparatus generated the output data in the predetermined time period before the current time, the judging module judges whether the vocal input is from the evaluation level table.

8. The robot apparatus as recited in claim 7, wherein if the vocal input is from the evaluation level table, the judging module determines that the vocal input is an evaluation voice; if the vocal input is not from the evaluation level table, the judging module determines that the vocal input is a conversation voice.

9. The robot apparatus as recited in claim 1, wherein the judging module judges the vocal input in a manner of directly judging whether the vocal input is from the evaluation level table; if the vocal input is from the evaluation level table, the judging module determines that the vocal input is an evaluation voice; and if the vocal input is not from the evaluation level table, the judging module determines that the vocal input is a conversation voice.

10. A vocal interactive method for a robot apparatus, wherein the robot apparatus stores a plurality of output data corresponding to conversation voices, a weighted value of each of the output data, and an evaluation level table, wherein the evaluation level table stores a plurality of evaluation voices and an evaluation level of each of the evaluation voices, and the weighted value of the output data is a direct ratio to the evaluation level of an evaluation voice responding to the output data, the method comprising:
receiving a vocal input from a user;
recognizing the vocal input;
determining that the vocal input is a conversation voice or an evaluation voice;
selecting one of the output data based on the weighted values of all the output data corresponding to the conversation voice, if the vocal input is a conversation voice;
outputting the selected output data responding to the conversation voice and recording the selected output data;
acquiring an evaluation level of the evaluation voice responding to the output data in the evaluation level table, if the vocal input is an evaluation voice; and
calculating the weighted value of the output data according to the evaluation level of the evaluation voice and updating the weighted value.

11. The vocal interactive method as recited in claim 10, further comprising storing output data corresponding to an undefined conversation voice that is not recorded in the robot apparatus.

12. The vocal interactive method as recited in claim 10, further comprising recording current time when outputting the output data for the conversation voice.

13. The vocal interactive method as recited in claim 12, wherein the step of determining that the vocal input is a conversation voice or an evaluation voice comprises:
judging whether the robot apparatus generated the output data in a predetermined time period before the current time;
determining that the vocal input is a conversation voice, if the robot apparatus did not generate the output data in the predetermined time period before the current time;
judging whether the vocal input is from the evaluation level table, if the robot apparatus generated the output data in the predetermined time period before the current time;
determining that the vocal input is an evaluation voice, if the vocal input is from the evaluation level table; and
determining that the vocal input is a conversation voice, if the vocal input is not from the evaluation level table.

14. The vocal interactive method as recited in claim 10, wherein the step of determining that the vocal input is a conversation voice or an evaluation voice comprises:
judging whether the vocal input is from the evaluation level table;
determining that the vocal input is an evaluation voice, if the vocal input is from the evaluation level table; and
determining that the vocal input is a conversation voice, if the vocal input is not from the evaluation level table.
